(19) United States
(12) Patent Application Publication
(10) Pub. No.: US 2016/0139740 A1
(43) Pub. Date: May 19, 2016

(54) METHOD AND SYSTEM FOR DISPLAYING SCHEDULE

(71) Applicants: Do Gyun KIM, (US); CREWMATE. CO., LTD, Seoul (KR)

(72) Inventor: Do Gyun KIM, Yangpyeong-gun (KR)

(73) Assignee: CREWMATE. CO., LTD, Seoul (KR)

(21) Appl. No.: 14/780,992

(22) PCT Filed: Feb. 27, 2014
(86) PCT No.: PCT/KR2014/001625

§ 371 Date: Jan. 25, 2016

(30) Foreign Application Priority Data
Mar. 28, 2013 (KR) 10-2013-0033166
Sep. 13, 2013 (KR) 10-2013-0110664

(51) Int. Cl. G06F 3/0482; G06Q 10/10

(52) U.S. Cl. CPC G06F 3/0482; G06Q 10/1097

(57) ABSTRACT

Disclosed are method and system for a displaying schedule. The method according to the technical concept of the present invention comprises, by a schedule display system, generating a coordinate system including a first axis and a second axis and generating a coordinate pattern including at least one coordinate corresponding to an activity. In the generated coordinate system, the first axis corresponds to an absolute time line and the second axis corresponds to a local time at a location of the activity.

### TECHNICAL FIELD

The present invention generally relates to a schedule display method and a system therefor. In particular, the present invention relates to a schedule display method and a system therefor, able to represent the schedules of a variety of activities (e.g. tasks, flights, bus, train, or the like) in an intuitive and easily-comparable form. More particularly, the present invention relates to a schedule display method and a system therefor able to intuitively represent schedules of activities (e.g. transportation services) that are to be undertaken in changing locations.

### BACKGROUND

In general, a number of flights may be scheduled to among remote cities. For example, airline tickets from Seoul to Rome are sold by about 40 airlines. Each airline sells airline tickets based on fare rules established for 500 or more flight schedules, depending on the number of transit cities and the number of flights among cities. This indicates the number of flights scheduled from Seoul to Rome is far more than generally estimated.

However, currently, online travel agencies and airlines display about 20 to about 50 representative flight schedules only. One important reason for this is that it may be difficult to compare a number of flight schedules via a table type interface created mainly in text.

FIG. 1 illustrates an example of a web interface providing flight information.

Referring to FIG. 1, the illustrated web interface provides a text-based list including available flight schedules to a destination for a passenger, the available flight schedules based on the lowest price being sequentially displayed from the top of the list. The flight schedules and additional information related thereto are provided in the left, and airline ticket prices are provided in the right. However, the text-based, table-type interface requires a user to read every flight schedules written in text in order to compare schedules. It is therefore difficult to analyze one flight schedule by comparison to the other flight schedules based by comparison of understood information after reading every written text. Also, text-based, table-type interfaces have difficulties in delivering various types of information. In addition, it is unsuitable for the user to intuitively grasp a flight schedule.

Therefore, flight schedule representing methods available for the user to view a number of flight schedules and makes determination therefrom are required.

For this, U.S. Pat. No. 6,307,572 proposed a more intuitive interface by representing flight schedules using a bar graph. The interface proposed in U.S. Pat. No. 6,307,572 will be described with reference to FIG. 2.

FIG. 2 corresponds to FIG. 24 illustrated in U.S. Pat. No. 6,307,572. Referring to FIG. 2, flight times and airport transit times between flights are displayed on the chart using bars type graph, depending on each flight schedules.

Since several flight schedules are displayed in a vertical direction on a single chart using the bar graph, a user can collectively compare the flight times and the airport transit times between flights in a flight schedule. In addition, the local times at the origin and the destination are displayed on the top or bottom of the graph, such that a departure time at the origin, an arrival time at the destination, an arrival time at the transit city, and a departure time at the transit city can be conceptualized using local times at the origin and the destination.

Although the bar graph of the flight schedules illustrated in FIG. 2 makes it easy to intuitively conceptualize total flying time, it is difficult to conceptualize local times depending on the locations of the flights, which is problematic. In addition, although the local times at the origin and the destination are displayed on the top or bottom of the graph, only two local times (i.e. the local times at the origin and the destination) can be displayed. Thus, when the flights fly via several transit cities, it is impossible to conceptualize the local times of the transit city, which is problematic.

In addition, when the flight schedules displayed in the vertical direction increase, information regarding the times of the origin and the destination on the top or bottom of the graph may become visually more remote, thereby making it difficult to conceptualize information regarding the departure time or the arrival time or compare the flight schedules.

In addition, some important factors for users to compare flight schedules, such as information regarding night flights and date changes during flights, must be analogically analyzed through comparisons of the times at the origin and at the destination, displayed in text on the top or bottom of the graph, instead of being visually provided. Therefore, the ability to efficiently provide information is limited.

### Technical Issue

The present invention is intended to provide a method of displaying schedule and a system therefor enabling a specific schedule to be more intuitively understood.

The present invention is also intended to provide a method of displaying schedule and a system therefor enabling a user to more intuitively understand valuable information, such as a local time and a date change, from schedules representing activities of traveling between different time zones, such as flight schedules.

### Technical Solution

In order to resolve the technical issue, provided is a schedule display method of displaying, in a schedule display system, a schedule corresponding to an activity. The method includes: generating, in the schedule display system, a coordinate system including a first axis and a second axis; and generating, in the schedule display system, a pattern of coordinates on the coordinate system generated thereby, the pattern of coordinates including at least one coordinate corresponding to the activity. The first axis corresponds to an amount of time consumed for the activity. The second axis corresponds to a local time at a location in which the activity is being carried out.

The at least one coordinate may include: a first coordinate representing a start of the activity; and a second coordinate representing an end of the activity.

The phase of generating the pattern of coordinates on the coordinate system may include generating the pattern of coordinates including a line including the first coordinate and the second coordinate or a geometric figure including the first coordinate and the second coordinate.

When the activity is performed while passing through a specific point in time in a local time at a location in which the activity is performed, the phase of generating the pattern of coordinates on the coordinate system may include generating a specific time pattern including at least one coordinate corresponding to the specific point in time.

The phase of generating the specific time pattern including the at least one coordinate corresponding to the specific point in time may include generating the specific time pattern including a third coordinate and a fourth coordinate respectively corresponding to two second axis values corresponding to the specific point in time.

The phase of generating the specific time pattern including the third coordinate and the fourth coordinate respectively corresponding to the two second axis values corresponding to the specific point in time may include generating the specific time pattern including a line or a geometric figure including the first coordinate and the second coordinate.

The phase of generating the specific time pattern including the at least one coordinate corresponding to the specific point in time may include generating the pattern of coordinates composed of a line or a geometric figure including the first coordinate and the third coordinate and a line or a geometric figure including the second coordinate and the fourth coordinate.

When a location in which the activity is performed is moved while the activity is being performed and a route of the location passes through the International Date Line, the phase of generating the pattern of coordinates on the coordinate system may include generating, in the schedule display system, a date change pattern representing the International Date Line.

The phase of generating the date change pattern representing the International Date Line may include: determining, in the schedule display system, a first-axis value (value on the first axis) corresponding to the date change pattern; and generating the date change pattern including a plurality of coordinates having the determined first-axis value.

The first-axis vale (value on the first axis) corresponding to the date change pattern may be determined by the following formula 1:

A+(B×D)/(24−C) Formula 1,

where A is a first-axis value of the first coordinate indicating a start of the activity, B is a distance between a first-axis vale of the second coordinate indicting an end of the activity and the first-axis vale of the first coordinate, C is a time difference between a location corresponding to the first coordinate and a location corresponding to the second coordinate, and D is a time difference between a location corresponding to the first coordinate and a location corresponding to the date change pattern.

The phase of generating the date change pattern representing the International Date Line may include generating, in the schedule display system, the date change patterns differently visualized depending on whether, when a location in which the activity is performed is moved, a direction in which the activity passes through the International Date Line matches a direction of rotation of the earth.

Also provided is a schedule display method of displaying, in a schedule display system, a schedule corresponding to an activity. The method includes: generating, in the schedule display system, a coordinate system including a first axis corresponding to time; and generating, in the schedule display system, a pattern of coordinates on the coordinate system generated thereby, the pattern of coordinates including at least one coordinate corresponding to the activity. When a location in which the activity is performed is moved while the activity is being performed and a route of the location passes through the International Date Line, the pattern of coordinates includes a date change pattern representing the International Date Line as a plurality of coordinates having a first axis value corresponding to the International Date Line. The above-described method of displaying schedule may be recorded as a program in a computer readable recording medium.

Also provided is a system for displaying a schedule corresponding to an activity as a pattern of coordinates. The system includes: a coordinate system generation module generating a coordinate system including a first axis and a second axis; and a control module generating a pattern of coordinates on the coordinate system generated by the coordinate system generation module, the pattern of coordinates including at least one coordinate corresponding to the activity. The first axis corresponds to an amount of time consumed by the activity, and the second axis corresponds to a local time at a location in which the activity is being performed.

Also provided is a system for displaying a schedule corresponding to an activity as a pattern of coordinates. The system includes: a coordinate system generation module generating a system of coordinates including a first axis and a second axis; and a control module displaying at least one coordinate corresponding to the activity on the coordinate system. When a location in which the activity is performed is moved while the activity is being performed and a route of the location passes through the International Date Line, the control module displays a date change pattern representing the International Date Line as a plurality of coordinates having a first axis value corresponding to the International Date Line.

### Advantageous Effects

According to the present invention, the schedule of an activity is displayed on a system of coordinates including an axis representing an amount of time consumed by the activity and an axis representing a local time at a location in which the activity is being performed. When there is a time difference between locations in which the activity is performed, valuable information can be intuitively delivered to a user.

In addition, it is possible to intuitively calculate days when an activity passing through the International Date Line is performed, or it is possible to intuitively conceptualize whether or not a specific point in time (e.g. midnight) will be passed at a location in which the activity is to be performed. Consequently, the user can easily make his/her schedule.

### BRIEF DESCRIPTION OF DRAWINGS

FIG. 1 illustrates an example of a web interface providing flight schedules;

FIG. 2 illustrates an example of an interface proposed in U.S. Pat. No. 6,307,572;

FIG. 3 illustrates a schematic configuration of a schedule display system according to an embodiment of the present invention;

FIG. 4 is a conceptual view illustrating a scheme of displaying a schedule corresponding to an activity on the coordinate system according to the embodiment of the present invention;

FIG. 5 is a conceptual diagram illustrating a scheme of displaying specific points in time on the coordinate system according to the embodiment of the present invention, in which an activity passes through the specific points in time while being performed;

FIG. 6 is a conceptual diagram illustrating a scheme of displaying a date change pattern on the coordinate system according to the embodiment of the present invention when an activity passes through the International Date Line while being performed;

FIG. 7 is a diagram illustrating a location in which a date change pattern is displayed according to the embodiment of the present invention;

FIG. 8 illustrates examples of coordinates according to the embodiment of the present invention; and

FIG. 9 illustrates an example in which patterns of coordinates according to the embodiment of the present invention are applied to a flight schedules.

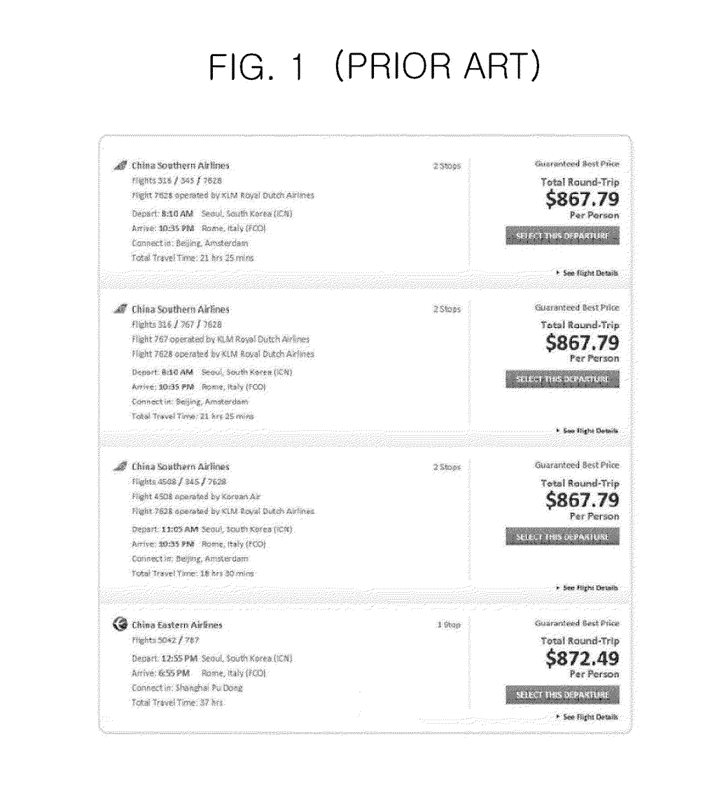

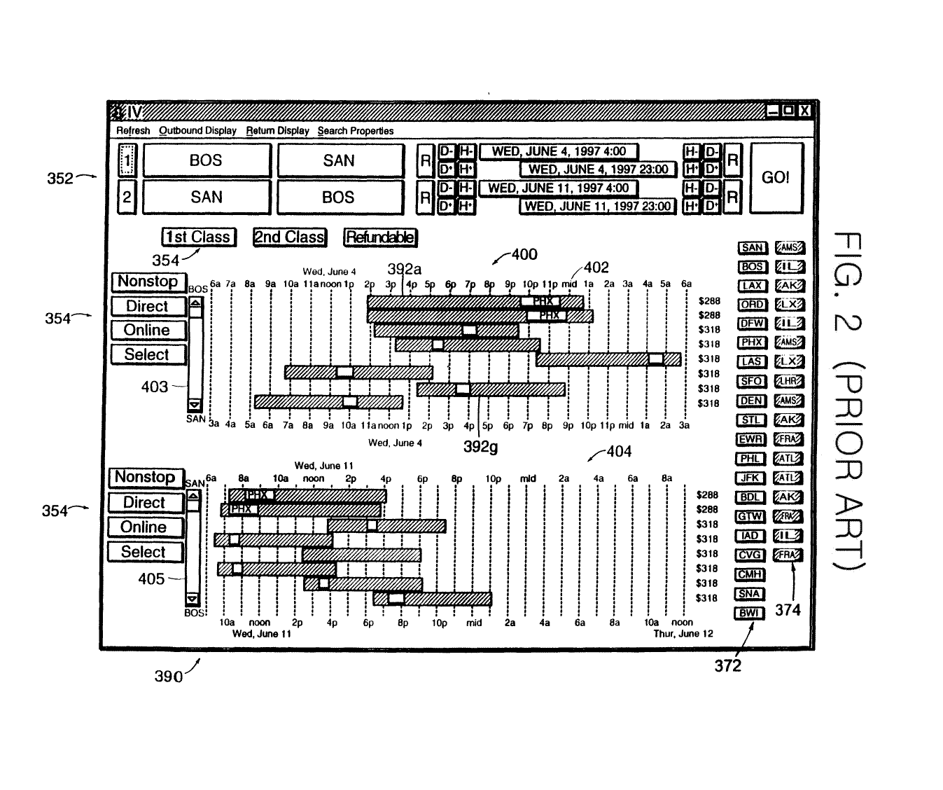

### DETAILED DESCRIPTION OF EMBODIMENTS

Reference will now be made in detail to various embodiments of the present invention, examples of which are illustrated in the accompanying drawings and described below. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims. In the following description, detailed descriptions of known functions and components incorporated herein will be omitted in the case that the gist of the present invention is rendered unclear.

It will be understood that, although the terms “first,” “second,” and the like may be used herein to describe various elements, these elements should not be limited by these terms. These terms are only used to distinguish one element from another element.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, and the like when used in this specification, specify the presence of stated features, integers, steps, operations, elements, components, and/or combinations thereof but do not preclude the presence or addition of one or more other features, integers, steps, operations, elements, components, and/or combinations thereof.

Herein, it will be understood that, when an element is referred to as “transmitting” data to another element, the element can not only directly transmit data to another element but also indirectly transmit data to another element via at least one intervening element. In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. The same reference numerals and signs are used throughout the different drawings to designate the same components.

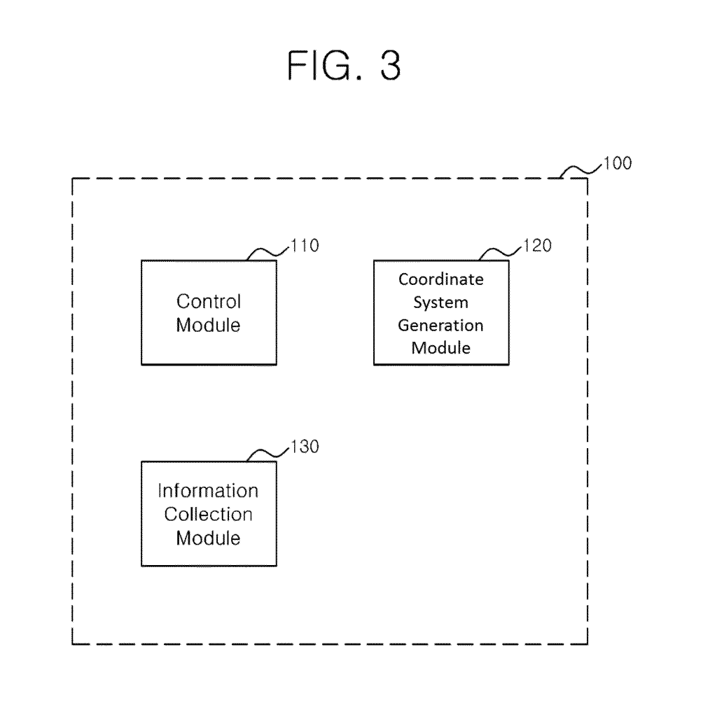

FIG. 3 illustrates a schematic configuration of a schedule display system according to an embodiment of the present invention.

Referring to FIG. 3, the schedule display system 100 according to an embodiment may be a system provided to display a schedule according to an embodiment of the present invention. The schedule display system 100 includes a control module 110 and a coordinate system generation module 120. The schedule display system 100 may also include an information collection module 130.

Although the schedule display system 100 is illustrated as being implemented as a single physical apparatus for the sake of convenience of explanation, the schedule display system 100 is not necessarily implemented as a single physical apparatus. The schedule display system 100 may be implemented as a plurality of discrete physical apparatus (e.g. servers) that may be systematically combined.

For example, the schedule display system 100 may be implemented as a server controlling a client (e.g. a user terminal) in a service platform having a client-server structure such that the client displays a schedule according to an embodiment an embodiment of the present invention. In some implementations, the schedule display system 100 may be disposed on a client to display a schedule according to an embodiment an embodiment of the present invention. In some implementations, some components of the schedule display system 100 may be disposed on the client and the server to display a schedule according to an embodiment an embodiment of the present invention.

When the schedule display system 100 is disposed on a client terminal, the schedule display system 100 may be implemented as any type of data processing device, such as a mobile phone or a tablet PC, having data processing ability in order to realize an embodiment of the present invention.

In this specification, the term “module” may refer to a functional and/or structural combination of hardware for realizing an embodiment of the present invention and software for enabling the hardware to operate. For example, the module may indicate a logical unit of codes and hardware resources executing the codes. It will be apparent to a person skilled in the art to which the present invention relates that the module does not necessarily indicate either physically-connected codes or only one type of hardware.

The control module 110 can control the functions and/or resources of the other components (e.g. the coordinate system generation module 120 and/or the information collection module 130) of the schedule display system 100 according to the present embodiment.

The coordinate system generation module 120 can generate a system of coordinates displaying a schedule according to an embodiment of the present invention. The schedule may be defined as data visually representing predetermined activity.

The activity may refer to all types of actions or performances, which is sufficiently allowed to be visually displayed the time for which the corresponding activity is performed. Subjects to perform the activities are not limited to humans but may be any subjects or objects (e.g. a transportation unit such as a flight or a train). For example, the activity may refer to the movement of a means of transportation, an action performed by a person (e.g. a specific action such as traveling or studying), or a combination thereof.

The coordinate system according to an embodiment of the present invention may include at least two axes. That is, the coordinate system for representing schedules according to an embodiment of the present invention is only required to include at least two axes. In addition, the coordinate system can be implemented as not only a two-dimensional (plane) system of coordinates, but also a system of coordinates having three or more dimensions.

The coordinate system includes a first axis and a second axis.

The first axis may be an axis corresponding to duration of an activity (event). The axis corresponding to duration of an activity may be an axis in which a difference between two values on the axis represents absolute duration of the event regardless of (independent from) a location of the activity (event). Thus, the first axis may be an axis representing time line at a specific location or an axis representing a time flow from a specific time point (e.g. a coordinate origin). For example, the schedule user interface (UI) illustrated in FIG. 2 generates a one-dimensional system of coordinates (a bar graph), which can be an example of a first axis according to embodiments of the present invention since the difference between a starting point and an ending point of a single bar indicates a total duration of a associated activity (flight schedule). Although points in time at different locations are indicated on the top and the bottom of the bar graph in FIG. 2, this may represent two axes of coordinates, i.e. two first axes, on which the amounts of time consumed are indicated.

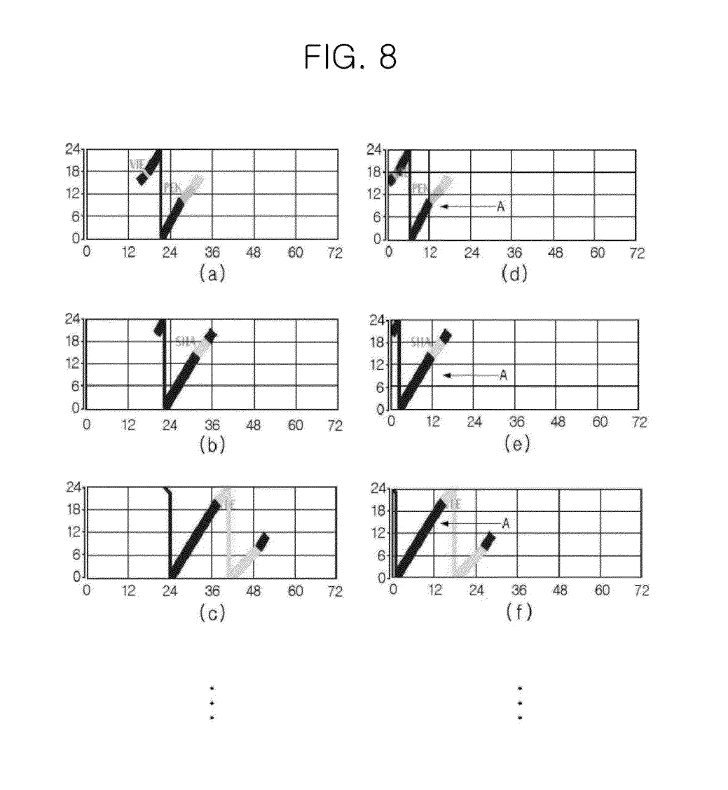

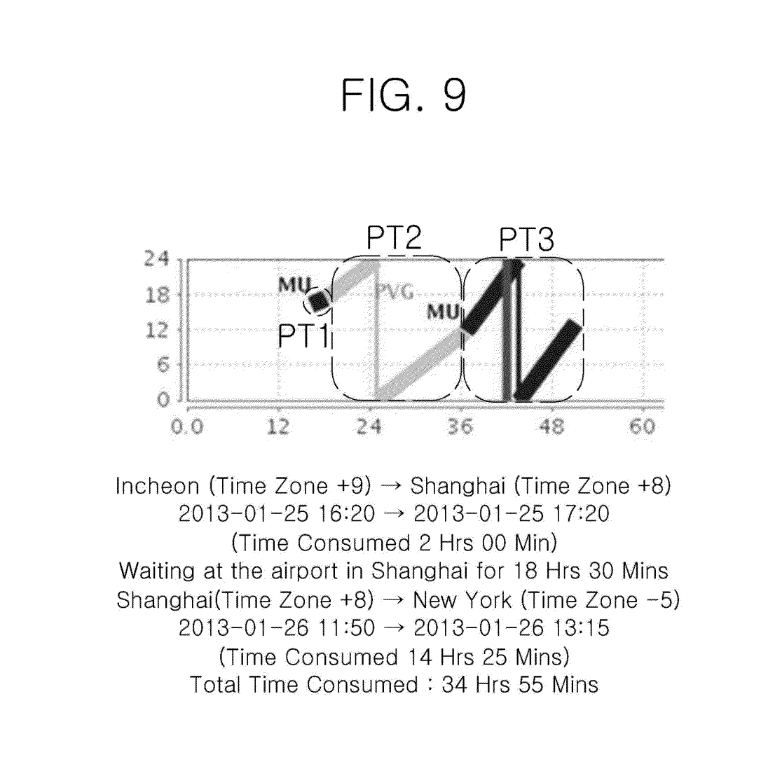

In addition, as will be illustrated in FIG. 8 or FIG. 9, the first axis may be an axis representing the lapse of time from the coordinate origin 0. A variety of embodiments are possible as long as a difference of the first axis value on the coordinate system can represent an amount of time consumed (elapsed) during the performance of an activity.

The second axis in the present invention may be an axis of coordinates indicating a local time at each time point of the activity, i.e. a local time in a location in which the activity is performed. The schedule displayed on the coordinate system including the second axis according to a certain embodiment of the invention may be useful especially when making a plan considering local times in a specific activity.

For example, when a specific activity is performed in two or more locations having a time difference there between, a user can directly conceptualize the local times of the locations from coordinates value of the second axis. Thus, the user can easily make a plan based on the local times, which is advantageous.

For example, an activity may be a flight schedule, in which a first location is an origin, a second location is a transit city, and a third location is a destination. In this case, referring to FIG. 2 of the related art, the local time at the first location and the local time at the third location is intuitively recognizable. However, in order to be aware of the local time at the second location, the user must perform calculation by inquiring the time difference between the second location and the first location (or third location), which may be inconvenient. In contrast, according to an embodiment of the present invention, the local time at the second location (transit city) can be intuitively (immediately) conceptualized, since the second axis always represents the local time at the location in which the activity is being performed. In this case, when the user want to stopover in the second location for a predetermined period of time, it is possible to very easily make a plan considering the local time at the second location. For example, it is possible to intuitively make a plan according to whether stopover at the second location is during the night or day, based on the schedule displayed according to an embodiment of the present invention.

Although the specification illustrates an example in which the second axis values of coordinates range from 0 to 24 hours, a variety of values, such as from 0 to 48 hours or 0 to 12 hours, may be used as a domain of the second axis according to implementations.

When the above-described system of coordinates including the first axis and the second axis is generated by the coordinate system generation module 120, the control module 110 can generate a schedule representing predetermined activity using a predetermined pattern of coordinates.

The pattern of coordinates may be generated by displaying at least one coordinate corresponding to the activity on the coordinate system. The at least one coordinate corresponding to the activity may be a coordinate corresponding to at least one event or point in time that is suitable to represent the activity.

For example, the at least one coordinate corresponding to the activity may include a coordinate representing the start of the activity (a starting event or a starting point in time) and a coordinate representing the end of the activity (an ending event or an ending point in time). The at least one coordinate corresponding to the activity may be a coordinate representing a specific event or a specific point in time (e.g. an intermediate point in time of the activity) during the performance of the activity, if necessary. In the specification, the at least one coordinate corresponding to the activity is illustrated by way of example as including at least a first coordinate representing the start of the activity and a second coordinate representing the end of the activity. However, it will be apparent to a person skilled in the art that the scope of the present invention is by no means limited thereto.

Consequently, the pattern of coordinates generated by the control module 110 can be represented by coordinates including the first coordinate and the second coordinate.

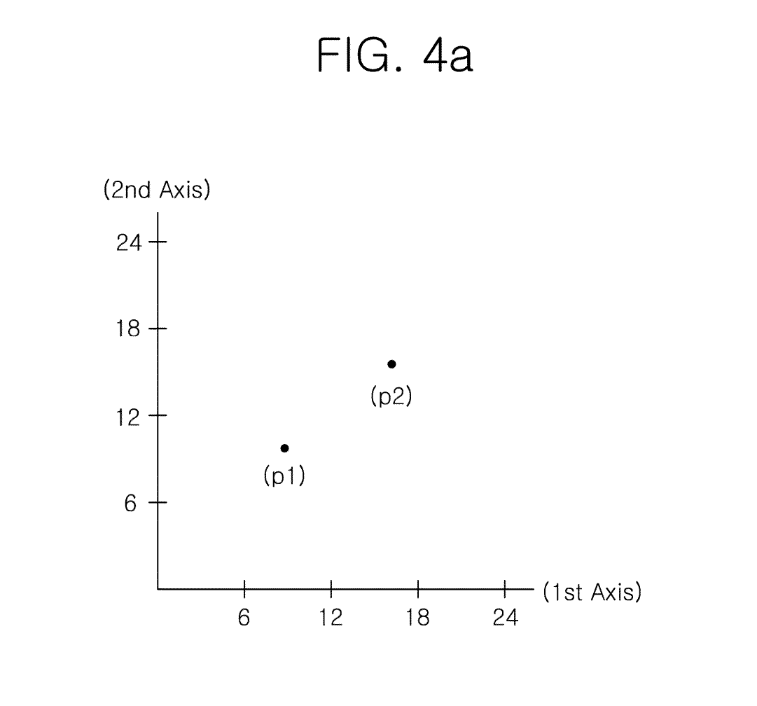

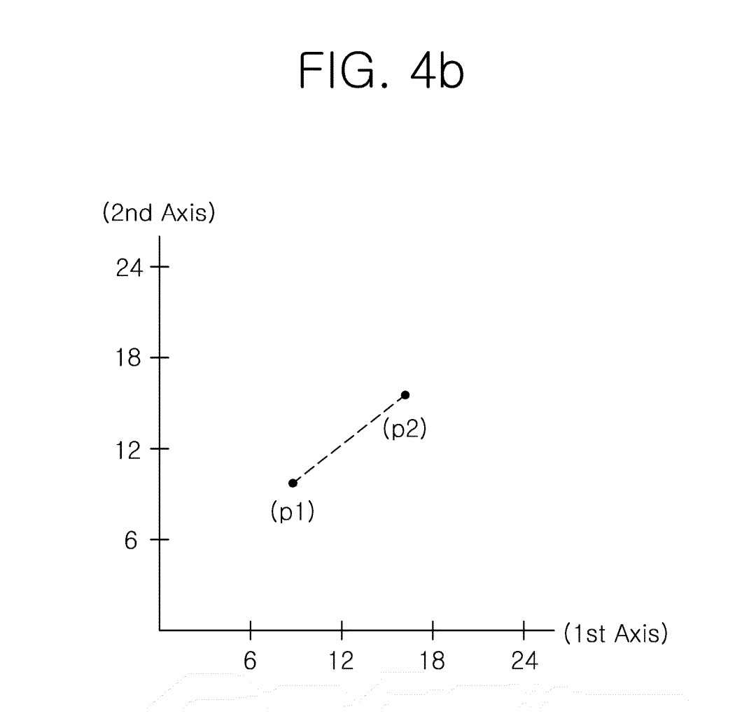

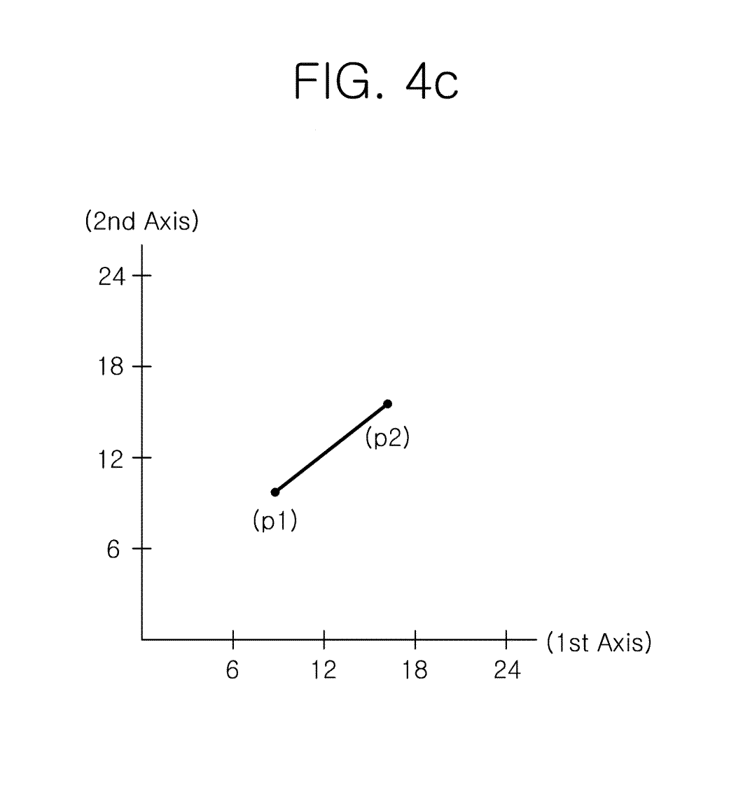

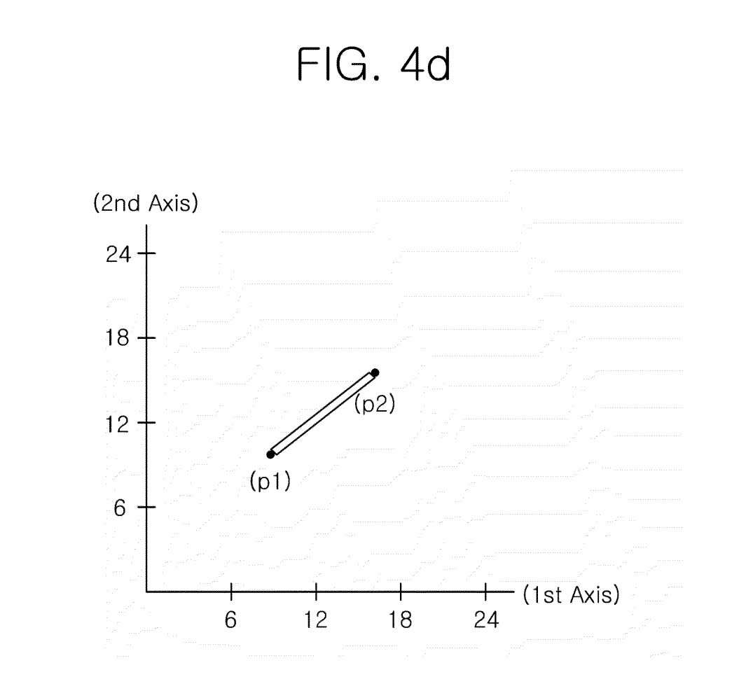

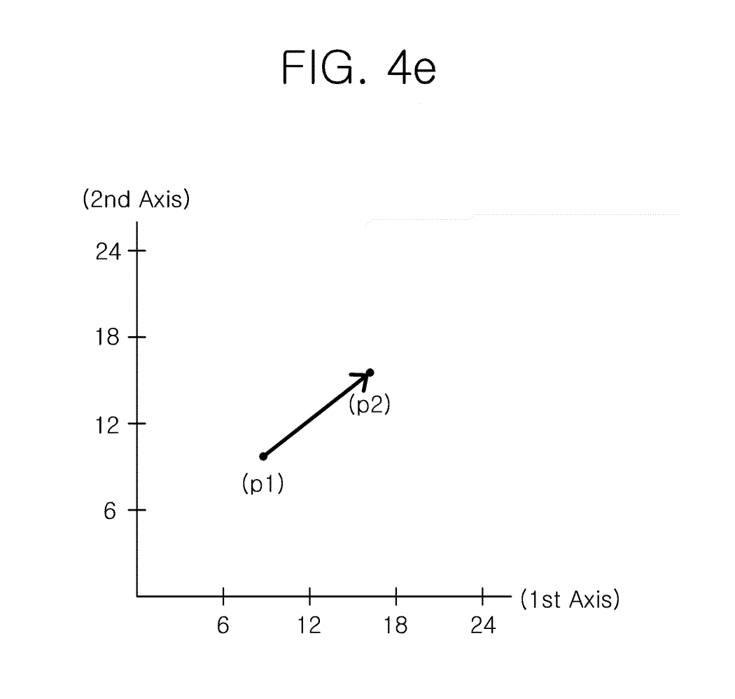

These examples are illustrated in FIG. 4.

FIG. 4 is a conceptual diagram of displaying a schedule corresponding to an activity on the coordinate system according to the embodiment of the present invention.

FIG. 4 illustrates examples of flight schedule, departing from Incheon, the Republic of Korea, arriving at Singapore, is represented using the pattern of coordinates according to an embodiment of the present invention. Here, the starting point in time of the activity is +9, 2013-03-19 09:00 local time, and the ending point in time of the activity is +8, 2013-03-19 14:25 local time. In addition, FIG. 4 illustrates a case in which the coordinate origin (baseline) is set for 0 AM local time of origin. A first axis value of the first coordinate P1 is 9:00, elapsed from the baseline +9, 2013-03-19 00:00 to the starting point in time+9, 2013-03-19 09:00, and a second axis value of the first coordinate P1 is also 9:00, since it is the local time at the starting point in time. In addition, a first axis value of the second coordinate P2 is 15:25, elapsed from the baseline +9, 2013-03-19 00:00 to the ending point in time +8, 2013-03-19 14:25, and a second axis value of the second coordinate P2 is 14:25, the local time in Singapore.

First, an example of the pattern of coordinates representing an activity described above will be explained with reference to FIG. 4a. The pattern of coordinates generated by the control module 110 may be a pattern of coordinates including only the first coordinate P1 and the second coordinate P2. The pattern of coordinates according to an embodiment of the present invention may be represented using only the first coordinate P1 and the second coordinate P2. In this case, the first coordinate P1 and the second coordinate P2 may be represented, if necessary, using different shapes. For example, the first coordinate P1 may be represented as a circle, and the second coordinate P2 may be represented as a quadrangle. In this manner, the coordinates representing the starting point in time and the ending point in time of the activity may be represented differently from each other.

In the meantime, the other examples in which the pattern of coordinates is generated (displayed) are illustrated in FIG. 4b and FIG. e 4c.

FIG. 4b illustrates an example in which the pattern of coordinates representing the activity includes the first coordinate P1 and the second coordinate P2 connected via a segment.

FIG. 4c illustrates an example in which the pattern of coordinates representing the activity includes the first coordinate P1 and the second coordinate P2 connected via a dotted line formed by marking dashes at predetermined intervals.

FIG. 4d illustrates an example in which the pattern of coordinates representing the activity is generated as a geometric figure including the first coordinate P1 and the second coordinate P2. Although the geometric figure is illustrated as a rectangle in FIG. 4d, a variety of other geometric figures, such as an ellipse, may be defined as the pattern of coordinates representing the activity. Any implementation is available as long as the pattern of coordinates includes the first coordinate P1 and the second coordinate P2 and is generated such that the user can easily recognize the first coordinate P1 and the second coordinate P2.

In addition, FIG. 4e illustrates an example in which the pattern of coordinates representing the activity includes the first coordinate P1 and the second coordinate P2 connected via an arrow.

In this manner, according to an embodiment of the present invention, it is possible to provide the pattern of coordinates representing the activity to the user by generating the pattern of coordinates on the coordinate system according to an embodiment of the present invention. The pattern of coordinates may be implemented as a variety of patterns of coordinates (e.g. a straight line, a segment, a curve, an arrow, and a geometric figure or etc.) including at least one coordinate (e.g. the first coordinate P1 and the second coordinate P2) corresponding to the activity. Here, the pattern of coordinates may be formed such that the at least one coordinate (e.g. the first coordinate P1 and the second coordinate P2) is easily recognizable to the user.

Returning to FIG. 3, the schedule display system 100 may have information regarding the activity (e.g. a starting location, a starting point in time, an ending location, an ending point in time, a transit location, a transit point in time, time zones at each location, or the like) directly input from the user, a manager, or the like in order to generate the pattern of coordinates as illustrated in FIG. 4. In some implementations, the schedule display system 100 can receive information regarding at least one activity from an external system and generate the pattern of coordinates based on the received information. For this, the schedule display system 100 may further include the information collection module 130.

The information collection module 130 can collect information required for the control module 110 to generate patterns of coordinates, i.e. information regarding an activity. The information collection module 130 is connected to an external system (e.g. an airline system, a railway system, a system storing information regarding location-specific time zones (differences in time), or the like) via a wired/wireless network, and can collect information regarding the activity therefrom. In some implementations, the information collection module 130 may receive the information regarding the activity input by the user (or a user or a manager of the schedule display system 100). In some implementations, a portion of the information regarding the activity may be input by the user, and the remaining portion the information regarding the activity may be received from the external system. For example, the information regarding the activity may be implemented as a variety of forms depending on what coordinate corresponds to the activity. When the coordinates corresponding to the activity include the first coordinate P1 and the second coordinate P2 as described above, information needed to display the first coordinate P1 and the second coordinate P2 on the coordinate system (e.g. a starting location, a local time in the starting location, a time zone in the starting location, an ending location, a local time in the ending location, a time zone in the ending location, and the like) may be included in the information regarding the activity.

In some implementations, as will be described later, the schedule display system 100 can have a specific time pattern representing a specific point in time or a date change pattern included in the pattern of coordinates corresponding to the activity. In this case, the information collection module 130 may receive information (e.g. the specific point in time, the presence of the International Date Line (or a route of the activity), an approximate location of the International Date Line, or the like), required to display the specific time pattern or the date change pattern on the coordinate system, input by a user or received from an external system.

An embodiment of the present invention provides a technical concept by which, when a local time in a location in which the activity is being performed pass a specific point in time, the specific point in time is displayed as being included in the pattern of coordinates. Since the specific point in time (e.g. midnight) in the location in which the activity is being performed is included in the pattern of coordinates (i.e. the user is allowed to easily recognize the specific point in time (e.g. midnight) in the location in which the activity is being performed), the user can easily make an intended plan based on the specific point in time while watching the schedule, i.e. the pattern of coordinates, according to an embodiment of the present invention.

Hereinafter, in this specification, although the specific point in time indicates midnight in the local time of the location in which the activity is performed, another point in time may be set as the specific point in time. When the pattern of coordinates indicating the predetermined activity according to an embodiment of the present invention includes the specific time pattern (e.g. a pattern of coordinates indicating midnight), it is possible to intuitively conceptualize how many times the specific point in time has passes through the entire schedule of the activity. In addition, as will be described later, when the activity is performed for a relatively long period, it may be easy to calculate days during which the activity is to be performed. Of course, the calculation of days may be intuitively performed by further referring to a date change pattern as will be described later.

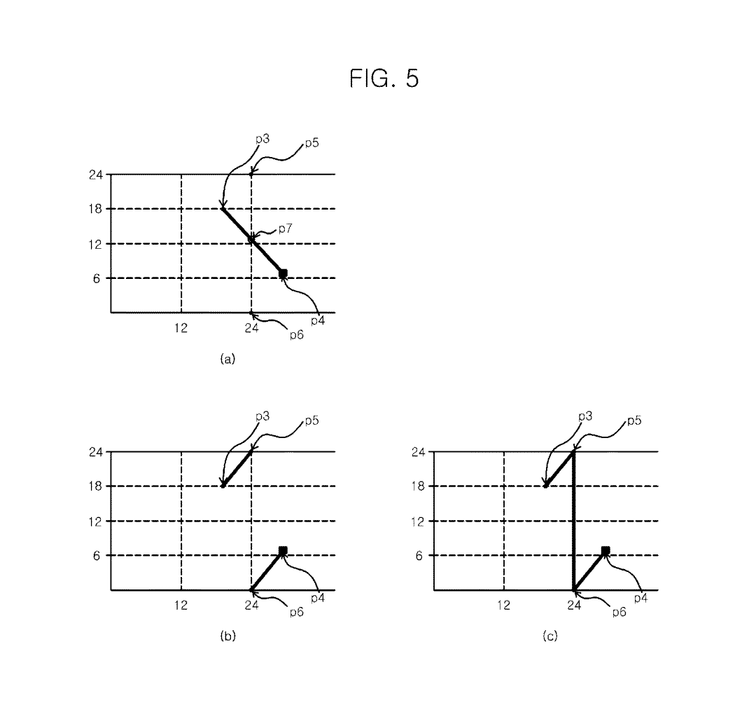

The specific time pattern will be described with reference to FIG. 5.

FIG. 5 is a conceptual diagram of displaying specific points in time on the coordinate system according to the embodiment of the present invention, in which an activity passes through the specific points in time while being performed.

FIG. 5 illustrates a case in which the specific point in time is midnight by way of example.

First, referring to FIG. 5a, at least one coordinate corresponding to the activity, i.e. a first coordinate P3 indicating the start of the activity and a second coordinate P4 indicating the end of the activity, may be displayed on the coordinate system according to an embodiment of the present invention.

In this case, although a pattern of coordinates representing the activity using lines or geometric figures including the first coordinate P3 and the second coordinate P4 as illustrated in FIG. 4 may be displayed on the coordinate system, a specific time pattern, i.e. a pattern representing a specific point in time (e.g. midnight), may be further displayed on the coordinate system.

The specific time pattern representing the specific point in time may be displayed as a pattern of coordinates in which at least one coordinate having same first axis value is included (e.g. a fifth coordinate P7, or a third coordinate P5 and a fourth coordinate P6). According to an embodiment, the at least one coordinate included in the specific time pattern may be a single coordinate. In this case, the pattern of coordinates including the first coordinate P3, the second coordinate P4, and the fifth coordinate P7 may be the pattern of coordinates representing the activity. Of course, the pattern of coordinates may further include a line or a geometric figure connecting the first coordinate P3 and the second coordinate P4. The fifth coordinate P7 can be positioned on a line connecting the first coordinate P3 and the second coordinate P4. A first axis value of the fifth coordinate P7 may be determined as a value corresponding to a specific point in time (e.g. midnight). In this case, a second axis value of the fifth coordinate P7 is not meaningful. Whether or not the specific point in time (e.g. midnight) has passed during the performance of the activity may be indicated depending on whether or not the fifth coordinate P7 is located on the pattern of coordinates (e.g. a segment connecting the first coordinate P3 and the second coordinate P4). The fifth coordinate P7 representing the specific time pattern is displayed using a shape different from that of either the first coordinate P3 or the second coordinate P4, such that the user can easily recognize whether or not the specific point in time has passed.

According to another embodiment, the specific time pattern may include two different coordinates (e.g. the third coordinate P5 and the fourth coordinate P6). That is, the specific time pattern may be displayed as a pattern of coordinates including two different coordinates (e.g. the third coordinate P5 and the fourth coordinate P6).

In this case, the pattern of coordinates representing the activity may be displayed as a pattern of coordinates including the first coordinate P3 and the second coordinate P4 as well as the third coordinate P5 and the fourth coordinate P6. Of course, the third coordinate P5 and the fourth coordinate P6 may be displayed so as to be distinguishable from the first coordinate P3 and/or the second coordinate P4.

The third coordinate P5 and the fourth coordinate P6 may be two coordinates corresponding to two different second axis values (24 hours or 0 hour) indicating the specific point in time (e.g. midnight).

In this case, the pattern of coordinates representing the activity may include only four coordinates (the first coordinate P3, the second coordinate P4, the third coordinate P5, and fourth coordinate P6). In some implementations, it is possible to display the activity as a pattern of coordinates allowing the user to visually recognize the presence of the specific time pattern in an easier manner while including the above-mentioned four coordinates. This example may be the pattern illustrated in FIG. 5b or FIG. 5c.

According to an embodiment, the control module 110 can generate a segment for an activity starting at the first coordinate P3, in the upper right direction along with the lapse of time. When the segment meets a coordinate (the third coordinate P5) corresponding to the specific point in time (e.g. 24 hours), the control module 110 can generate a segment from the other coordinate (the fourth coordinate P6) corresponding to the specific point in time, in the upper right direction, such that the segment is connected to the second coordinate P4 corresponding to the end of the activity. The resultant pattern of coordinates may be the pattern illustrated in FIG. 5b. Of course, the pattern of coordinates representing the activity may be displayed as various types of lines (a curve, an arrow, or the like) or a geometric figure instead of the segment.

In addition, the control module 110 can specify the first coordinate P3, the second coordinate P4, the third coordinate P5, and the fourth coordinate P6 in advance before generating a pattern of coordinates including the first coordinate P3 and the third coordinate P5 and a pattern of coordinates including the second coordinate P4 and the fourth coordinate P6.

When every coordinate corresponding to every point in time at which the activity is performed is displayed on a system of coordinates including the first axis and the second axis according to an embodiment of the present invention the coordinate in which the second axis value has the specific point in time (e.g. midnight) may not be displayed in some cases.

For example, provided the starting point in time of the activity is +8, 2013-3-19 23:30 and the ending point in time of the activity is +9, 2013-3-20 00:50, midnight may be regarded to be present between the starting point in time and the ending point in time of the activity. However, considering the actual amount of time consumed is only 0:20, there is a problem in that the local times of the activity can have only a range from 23:30 to 23:50 and a range from 00:30 to 00:50. That is, the activity does not actually pass through the specific point in time in either the location corresponding to the start thereof or the location corresponding to the end thereof. Thus, even in the case in which coordinates are marked on the coordinate system at any point in time in which the activity is performed, there may be no actual coordinate, the second axis value of which corresponds to the specific point in time (e.g. midnight, i.e. 0 hour or 24 hours). This problem occurs because a time difference is expressed discontinuously instead of being continuous.

In this case, it may be more consistent with the facts to indicate that the activity has passed the specific point in time (e.g. midnight) even if the activity has not passed midnight in the local time of any of the two locations. That is, in the case in which the activity may have passed the specific point in time if the activity were in one location, excluding the specific time pattern indicating the specific point in time from the pattern of coordinates due to the discontinuity of the time difference may resultantly provide wrong information (or misleading information) to the user.

Therefore, the specification provides a technical concept able to display the specific time pattern in a predetermined location in such a case.

According to an embodiment of the present invention, the third coordinate P5 and the fourth coordinate P6 included in the pattern of the specific point in time (e.g. midnight) may have the same first axis value, and a first line connecting the first coordinate P3 and the third coordinate P5 and a second line connecting the second coordinate P4 and the fourth coordinate P6 may be set to be parallel to each other. Although the third and fourth coordinates P5 and P6 have different second axis values, both the second axis values of the third and fourth coordinates P5 and P6 may include specific points in time (e.g. 0 hour and 24 hours).

Since the first line and the second line are set to be parallel to each other in the case in which the starting point in time and the ending point in time have no time difference there between, the activity is set to have the same incline on the assumption that the activity moves at a constant velocity between the starting point in time and the ending point in time even in the case that there is a time difference. Consequently, the first axis value corresponding to the specific time pattern can be reasonably set.

In addition, as illustrated in FIG. 5c, the control module 110 may cause the pattern of coordinates to include lines or geometric figures having the coordinates (the third coordinate P5 and the fourth coordinate P6) corresponding to the specific time pattern such that the specific time pattern can be more intuitively conceptualized. For example, when the specific time pattern is formed as a segment having the third coordinate P5 and the fourth coordinate P6 on both endpoints, the pattern of coordinates representing the activity may have a pattern as illustrated in FIG. 5c.

As such, according to an embodiment of the present invention, not only coordinates (e.g. the first coordinate P3 and the second coordinate P4) corresponding to an activity, but also a specific time pattern (e.g. the fifth coordinate P7, or the third coordinate P5 and the fourth coordinate P6) representing a meaningful specific point in time is displayed by a variety of methods as illustrated in FIG. 5. Consequently the user can easily recognize whether or not the specific point in time has passed, during the performance of the activity, in a location in which the activity is performed.

When the activity is performed in the specific locations in the same time zone, it is possible to intuitively conceptualize a date or dates on which the entire activity is performed by counting the number of specific time patterns in the pattern of coordinates representing the activity. For example, when x number of specific time patterns (x is a natural number) are present from the starting point in time to the ending point in time of the activity, the activity can be intuitively conceptualized as ending x days after the starting date. Thus, it is possible to easily calculate the date on which the activity ends in the location in which the activity ends.

When an activity is performed while moving from one location to another (e.g. as in a transportation schedule), the activity may be performed while passing through the International Date Line. In this case, the International Date Line may be included in the pattern of coordinates that represents the activity. This may be available for conceptualizing the local date at a predetermined point in time or at the ending point in time while the activity is being performed.

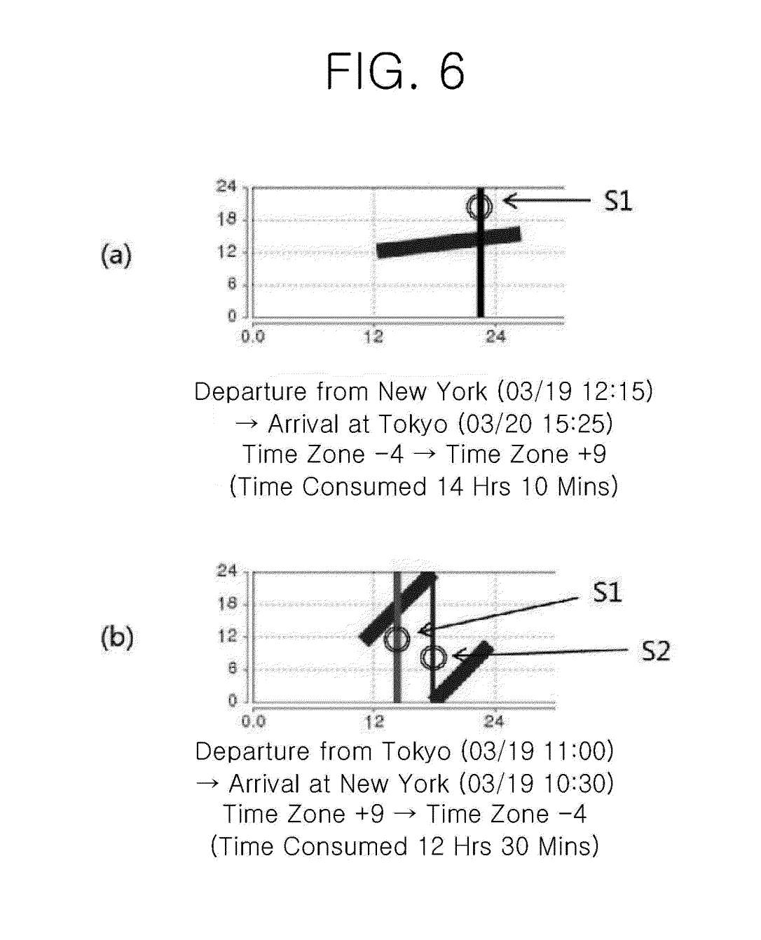

This technical concept will be described with reference to FIG. 6.

FIG. 6 is a conceptual diagram illustrating a scheme of displaying a date change pattern on the coordinate system according to the embodiment of the present invention while an activity is being performed.

FIG. 6a illustrates a pattern of coordinates representing an activity departing from New York at 03/19 12:15 local time (−4 time zone) and arriving at Tokyo at 03/20 15:25 local time (+9 time zone), in which the amount of time consumed may be 14 hours and 10 minutes.

In addition, FIG. 6b illustrates a pattern of coordinates representing an activity departing from Tokyo at 03/19 11:00 local time and arriving at New York at 03/19 10:30 local time, in which the amount of time consumed may be 12 hours and 30 minutes.

Referring to FIG. 6a and FIG. 6b illustrating a pattern of coordinates, the schedule display system 100 according to the embodiment of the present invention can display the date change patterns illustrated in FIG. 6a and FIG. 6b as a pattern of coordinates representing an activity.

When the activity is an activity (e.g. a transportation schedule) performed while changing locations, the date change pattern S1 may be information indicating that the route of the activity pass through the International Date Line. Although FIG. 6a or FIG. 6b illustrates a case in which the date change pattern is marked with a segment S1 perpendicular to the first axis, the date change pattern can also be displayed as a variety of patterns (e.g. a coordinate, a curve, or a geometric figure) including at least one coordinate corresponding to the date change pattern, in the manner the same as or similar to the example of specific time pattern illustrated in FIG. 5.

In addition, FIG. 6a or FIG. 6b illustrates an example of a pattern of coordinates in which both end points of a blue line illustrated therein indicate a first coordinate and a second coordinate of the activity as described above. The first coordinate and the second coordinate are connected via a segment in the same manner as illustrated in FIG. 4 or FIG. 5 above.

The date change pattern may be divided into different types depending on the route (direction) of the activity based on the International Date Line. For example, the first date change pattern may be a pattern that is displayed when the route of the activity pass through the International Date Line while moving in the opposite direction of the rotation of the earth. In addition, the second date change pattern may be a pattern that is displayed when the route of the activity pass through the International Date Line while moving in the direction of the rotation of the earth. The control module 110 can display the first date change pattern (e.g. the segment S1 marked in black in FIG. 6a) and the second date change pattern (e.g. the segment S1 marked in red in FIG. 6b) on the coordinate system such that the first and second date change patterns are visually distinct from each other. For this, the patterns may be displayed as different types (e.g. a segment, a curve, a geometric figure, or the like), or when the patterns are of the same type (e.g. a segment), the properties of the patterns (e.g. the thickness or the color of the segment) may be displayed differently.

Thus, when the first date change pattern is displayed on the coordinate system, the data of a coordinate positioned in the first direction (e.g. to the left) of the first axis direction with respect to the location in which the first date change pattern is displayed may be one day before the date of a coordinate positioned in the second direction (e.g. to the right) opposite to the first direction. That is, it is possible to calculate the date of the coordinate positioned to the right of the first date change pattern S1 with respect to the first axis in FIG. 6a by adding one day to the date of the coordinate positioned to the left of the first date change pattern S1.

In contrast, when the second date change pattern (e.g. S1 in FIG. 6b) is displayed on the coordinate system, the date of a coordinate positioned in the first direction (e.g. to the left) of the first axis direction with respect to the location in which the second date change pattern is displayed may be one day after the date of a coordinate positioned in the second direction (e.g. to the right) opposite to the first direction. That is, it is possible to calculate the date of the coordinate positioned to the right of the second date change pattern S1 with respect to the first axis in FIG. 6b by subtracting one day from the date of the coordinate positioned to the left of the second date change pattern S1.

The case in which the date change pattern is included in the pattern of coordinates representing a predetermined activity in this manner has the following effect: A local date at a predetermined point in time (coordinate) can be easily calculated even in the case in which there is a time difference or the activity pass through the International Date Line. In addition, when the above-described specific time pattern (e.g. a pattern representing midnight) is displayed as being included in the pattern of coordinates, a date at a location in which the activity is performed can be more easily calculated.

For example, in the case of FIG. 6a, the first date change pattern (+1 day) is present. Thus, the ending point in time of the activity can be intuitively conceptualized as being one day after the starting point in time of the activity.

In addition, in the case of FIG. 6b, the second date change pattern (−1 day) is present and midnight line (+1 day) is present. Thus, the ending point in time of the activity can be intuitively conceptualized as being on the same date as the starting point in time of the activity.

Since the date change pattern is additionally displayed on the pattern of coordinates representing the activity, the user can easily calculate a local date at any point in time.

In the meantime, it is preferable that this date change pattern is displayed at a first axis value corresponding to a theoretically exact point in time at which the activity is to pass through the International Date Line (i.e. a first axis value corresponding to the amount of time consumed from the starting point in time of the activity to the point in time at which the activity pass through the International Date Line).

However, it may be difficult or impossible to find an exact point in time at which the International Date Line will be passed through and display the found point in time in an exact position (i.e. a first axis value) on the coordinate system according to the present invention.

This is because the International Date Line is not marked as a straight line on the map but includes bent sections. In addition, it is very difficult to find an exact time when the activity will pass through the International Date Line depending on the type of the activity or a variety of external parameters (e.g. the speed of the movement of the activity, weather conditions, air currents, and the like).

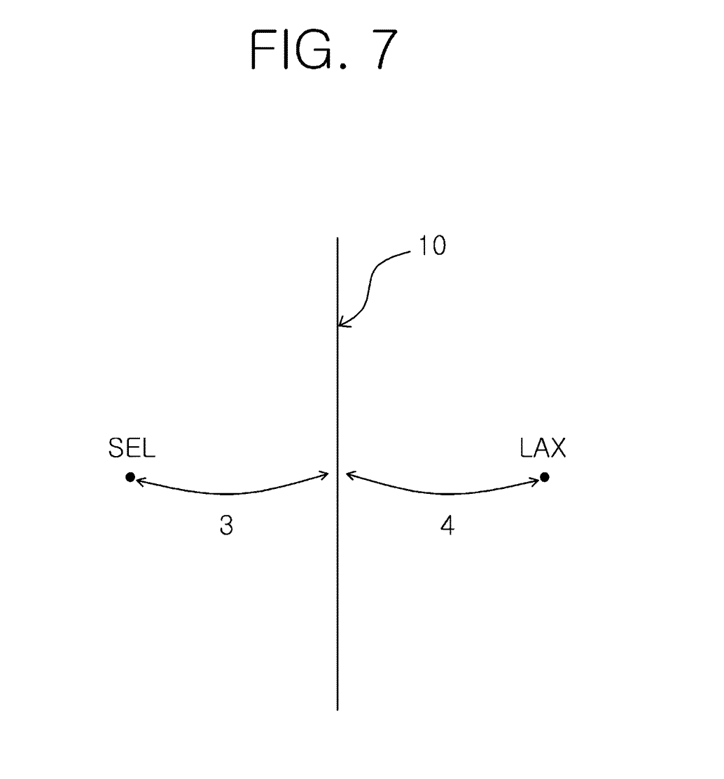

Therefore, an embodiment of the present invention further provides a technical concept by which the position (the first axis value) in which the date change pattern will be displayed is reasonably determined regardless of such difficulties. Such an example will be described with reference to FIG. 7.

FIG. 7 is a diagram illustrating a location in which a date change pattern is displayed according to the embodiment of the present invention.

FIG. 7 is a diagram conceptually illustrating a position in which a date change pattern in an activity of a flight schedule from Seoul, the time zone of which is +9, to LA, the time zone of which is −8, is to be displayed. Here, the International Date Line 10 may be displayed as a time zone ±12. In addition, SEL and LAX are the city codes indicating Seoul and LA in the flight schedule.

In the example illustrated in FIG. 7, the time difference between a location corresponding to the start of the activity (e.g. Seoul) and the International Date Line may be 3 hours, and the time difference between a location corresponding to the end of the activity (e.g. LA) and the International Date Line may be 4 hours.

In this case, when the total amount of time consumed by the activity is, for example, 14 hours, position (i.e. a first axis value) of the date change pattern may be a position which divides a segment by 3:4, the segment connects the first axis value of the first coordinate indicating the starting point in time of the activity and the first axis value of the second coordinate indicating the ending point in time of the activity. That is, according to an embodiment of the present invention, a position (a first axis value) in which the date change pattern is to be displayed may be a position (a first axis value) in which a segment connecting the first axis values corresponding to the start and the end of the activity is internally divided in proportion to the time difference (e.g. 3 hours) between the location (e.g. Seoul) at the starting point in time of the activity and the International Date Line and the time difference (e.g. 4 hours) between the International Date Line and the location (e.g. LA) at the ending point in time of the activity.

For example, in the activity illustrated in FIG. 7, when the first axis value of the starting point in time is 0 and the amount of time consumed is 14 hours, the first axis value of the ending point in time of the activity is 14 hours. In this case, the position in which the range from 0 to 14 is divided by a ratio of 3:4 is 6, 14×3/7. Thus, the date change pattern of the activity can be displayed on a location in which the first axis value is 6.

Consequently, since a exact point in time at which the International Date Line will be passed through cannot be found, an embodiment of the present invention can assume a case in which the activity moves from the starting point of the activity to the ending point in time of the activity at a constant velocity. In this case, it is possible to estimate a virtual point in time at which the International Date Line will be passed through (i.e. the amount of time consumed from the starting location to the International Date Line will be passed through) based on the ratio of the time difference between the starting point and the International Date Line to the time difference between the ending location and the International Date Line.

A method of estimating a position in which date change pattern will be displayed can be generalized by the following formula:

A+(B×D)/(24−C) [Formula 1]

Here, A, B, C, and D indicate a first axis value of a starting point in time of an activity, an amount of time consumed from the starting point in time of the activity to an ending point in time of the activity, a time difference between the starting point in time and the ending point in time of the activity, and a time difference between the starting point in time of the activity and the International Date Line.

When Formula 1 is applied to the above-described example, A is 0, B is 14, C is 17, and D is 3. It can be understood that the resultant value obtained from Formula 1 is 14×3/7 as described above.

Of course, a person skilled in the art to which the present invention relates can readily understand that the above-described effects can be obtained by merely displaying the date change pattern in a predetermined position while the activity is being performed even if the date change pattern is not displayed in the position corresponding to the calculated first axis value after the first axis value corresponding to the date change pattern is calculated in this manner.

FIG. 8 illustrates example of coordinates according to the embodiment of the present invention.

Diagrams in FIG. 8 illustrate that the first axis values of first coordinates indicating the start of activities representing flight schedules can be set variously according to a variety of implementations.

Specifically, in the patterns of coordinates illustrated in FIG. 8, FIG. 8a and FIG. 8d, FIG. 8b and FIG. 8 e, and FIG. 8c and FIG. 8f indicate cases in each of which the same activity is displayed using different first coordinates.

For example, FIG. 8a, FIG. 8b, and FIG. 8c illustrate cases in which the first axis value of the first coordinate indicates a local time at the starting location of the activity. The first axis value in FIG. 8a may indicate, for example, 15 hours, the local time at the starting point of the activity. In addition, the activity illustrated in FIG. 8a may be displayed as a pattern of coordinates illustrated in FIG. 8d in which first axis values indicate absolute amounts of time consumed.

Likewise, FIG. 8b may be displayed as a pattern of coordinates illustrated in FIG. 8e, depending on what first axis values indicate. In addition, FIG. 8c may be displayed as a pattern of coordinates illustrated in FIG. 8f.

As illustrated in FIG. 8, a single activity may be divided into sub-activities, and the patterns of coordinates corresponding to the different sub-activities may be displayed to be visually distinct from each other. For example, in the pattern of coordinates illustrated in FIG. 8a, segments (e.g. patterns of coordinates) marked in different colors may be patterns of coordinates representing different activities (e.g. stopover in transit city) or may be patterns of coordinates representing different flight schedules.

That is, an embodiment of the present invention may display the sub-activities (e.g. an operation of a flight, a stopover, an operation of a transfer flight) of one activity using the above-described patterns of coordinates.

Of course, a pattern of coordinates representing one activity and a pattern of coordinates another activity performed in continuation of the former activity can be continuously displayed on the coordinate system. In addition, even in the case in which the patterns of coordinates according to the activities are displayed as different patterns (e.g. a line, a curve, an arrow, a geometric figure, or the like) such that the patterns are visually distinct from each other or are displayed as the same pattern (e.g. a segment), the patterns may be marked in different colors, thicknesses, or the like.

FIG. 9 illustrates an example in which patterns of coordinates according to the embodiment of the present invention are applied to a flight schedule.

In the example illustrated in FIG. 9, activities are displayed as patterns of coordinates according to an embodiment of the present invention. Specifically, the activities include a departure from Incheon in +9 time zone at 16:20 local time, Jan. 25, 2013; an arrival at Shanghai in +8 time zone at 17:20 local time, Jan. 25, 2013; waiting at the airport in Shanghai for 18 hours and 30 minutes; a departure from Shanghai at 11:50 local time, Jan. 26, 2013; and an arrival at New York in −5 time zone at 13:15 local time, Jan. 26, 2013.

A pattern of coordinates PT1 represents an activity of moving from Incheon to Shanghai, a pattern of coordinates PT2 represents an activity of staying in Shanghai, and a pattern of coordinates PT3 represents an activity of moving from Shanghai to Incheon.

A series of activities can be displayed according to an embodiment of the present invention as above. When FIG. 9 is provided from the schedule display system 100, a user can easily conceptualize the entire amount of time to be consumed by comparing the first axis value of the coordinate corresponding to the departure from Incheon and the first axis value of the coordinate corresponding to the arrival at New York, i.e. the first axis value of the leftmost coordinate in the entire patterns and the first axis value of the rightmost coordinate in the entire patterns.

In addition, since a specific time pattern indicating a specific point in time (midnight) is displayed on the pattern of coordinates PT2, it can be conceptualized that the activity passes through the specific point in time (midnight) in Shanghai.

Furthermore, since the specific time pattern (a midnight pattern) and a second date change pattern are included in the pattern of coordinates PT3, it is possible to easily recognize the local date at the departure and the local date on the arrival is same in the activity corresponding to the pattern of coordinates PT3, i.e. the activity of moving from Shanghai to New York.

In addition, since the specific time pattern (the midnight pattern) is displayed two times and the second date change pattern is displayed one time in the entire patterns of coordinates, it is possible to intuitively conceptualize that one day has passed based on the date in the local time (Jan. 25, 2013) corresponding to the start of the initial activity (the departure from Incheon) and the date in the local time (Jan. 26, 2013) corresponding to the end of the final activity (the arrival at New York) during the performance of the entire activities.

In addition, while the entire activities are being during performed, the local time at an arbitrary point in time can be immediately recognized based on the second axis value of the coordinate corresponding to the arbitrary point in time.

According to an embodiment of the present invention, a schedule representing a variety of activities is displayed using patterns of coordinates as described above, such that the schedule can be intuitively conceptualized. In particular, this can be useful especially in the case in which a time difference is caused by the movement of a location in which an activity is performed. In addition, when a series of activities are continuously performed such that the locations of the activities are changed frequently, local times at the locations can be immediately grasped in an easy manner, and dates at the locations can also be easily calculated.

In the meantime, in an embodiment of the present invention, the technical concept of displaying a specific time pattern or a date change pattern on a pattern of coordinates representing a specific activity is not limitedly applied to the coordinate system according to an embodiment of the present invention (i.e. the coordinate system in which the first axis corresponds to the amount of time consumed and the second axis corresponds to the local time at a location in which the activity is performed).

For example, when a specific point in time has passed, not only the one-dimensional system of coordinates as illustrated in FIG. 2 but also a variety of systems of coordinates can display a specific time pattern in a variety of schemes, the specific time pattern representing that the specific point in time has passed. In addition, the date change pattern can be displayed in a predetermined manner in order to represent that the route of an activity passes through the International Date Line while the activity is being performed. In this case, as described above, it may be easy to calculate days.

In the meantime, the schedule display method according to embodiments of the present invention may be embodied as computer readable program instructions stored in a computer readable recording medium. A control program and an object program according to embodiments of the present invention may be stored in the computer readable recording medium. The computer readable recording medium includes all sorts of recording devices in which data readable by a computer system are stored.

The program instructions stored in the recording medium may be program instructions specially designed and constructed for the present invention or program instructions known and available to a person skilled in the field of software.

Examples of the computer readable recording medium include magnetic media, such as a hard disk, a floppy disk, and a magnetic tape; optical media, such as compact disc read only memory (CD-ROM) and a digital versatile disk; magneto-optical media, such as a floptical disk; and other hardware devices specially designed to store and execute program instructions, such as read only memory (ROM), random access memory (RAM), and flash memory. In addition, the recording medium may be in the form of light or a carrier wave that conveys signals specifying program instructions, data structures, or the like, or a transmission medium, such as a metal wire or a waveguide, through which the signals are transmitted. Furthermore, the computer readable recording medium may be distributed to computer systems connected by means of a network, in which computer readable codes are stored and executed in a decentralized manner.

Examples of the program instructions include not only machine language codes generated by compilers, but also advanced language codes that may be executed by an information processing device, for example, a computer, that electronically processes information using an interpreter.

The hardware devices described above may be constructed such that they can operate as one or more software modules for performing the operations of the present invention, and vice versa.

While the present invention has been illustrated and described with reference to the certain exemplary embodiments thereof, it will be understood by those skilled in the art that various changes in form and details may be made therein without departing from the spirit and scope of the present invention as defined by the appended claims. Therefore, the foregoing embodiments should be understood as being illustrative but not limitative purposes. For example, some parts described as being located in a single physical entity can be implemented as being distributed to a plurality of physical devices. In the same fashion, some parts described as being distributed to a plurality of physical devices can be located in a single physical entity.

The scope of the present invention is defined not by the detailed description but by the appended claims, and all modifications and alterations derived from the concept, the range, and the equivalents of the claims will be construed as being included in the scope of the present invention.

### INDUSTRIAL APPLICABILITY

The present invention is applicable to a system displaying a variety of schedules, such as flight schedules.

1-16. (canceled)

17. A computer implemented method of displaying a schedule of an activity, the method comprising:
generating a coordinate system including a first axis and a second axis; and
generating a pattern of coordinates on the generated coordinate system, the pattern of coordinates including at least one coordinate of the activity,
wherein the first axis represents an absolute time line independent from a location of the activity, and the second axis represents a local time line at the location of the activity.

18. The method according to claim 17, wherein the at least one coordinate comprises:
a first coordinate representing a start of the activity; and
a second coordinate representing an end of the activity.

19. The method according to claim 18, wherein generating the pattern of coordinates on the coordinate system comprises:
generating a pattern comprising a line including the first coordinate and the second coordinate or a geometric figure including the first coordinate and the second coordinate.

20. The method according to claim 18, wherein, when the activity takes place at a specific time in local time of a location of the activity, generating the pattern of coordinates on the coordinate system comprises:
generating a specific time pattern including at least one coordinate representing the specific time.

21. The method according to claim 20, wherein the specific time pattern includes a third coordinate and a fourth coordinate corresponding to two second axis values corresponding to the specific time.

22. The method according to claim 21, wherein the specific time pattern comprises a line or a geometric figure including the third coordinate and the fourth coordinate.

23. The method according to claim 21, further comprising generating a pattern of coordinates that comprises a line or a geometric figure including the first coordinate and the third coordinate and a line or a geometric figure including the second coordinate and the fourth coordinate.

24. The method according to claim 21, wherein the pattern of coordinates comprises a first line including the first coordinate and the third coordinate and a second line including the second coordinate and the fourth coordinate, wherein the first line and the second line are set to be parallel to each other.

25. The method according to claim 18, further comprising: when the activity includes a travel crossing the International Date Line, generating a date change pattern representing the International Date Line.

26. The method according to claim 25, wherein generating date change pattern representing the International Date Line comprises:
determining a value on the first axis corresponding to the date change pattern; and
generating the date change pattern including a plurality of coordinates having the determined value.

27. The method according to claim 26, wherein the value corresponding to the date change pattern on the first axis is determined by the following formula:
A+(B×D)/(24−C)
where A is a first value of the first coordinate on the first axis, B is a difference between the first value and a second value of the second coordinate on the first axis, C is a time difference between a location corresponding to the first coordinate and a location corresponding to the second coordinate, and D is a time difference between a location corresponding to the first coordinate and a location corresponding to the date change pattern.

28. The method according to claim 27, wherein the date change patterns are visualized differently depending on whether a direction of the travel crossing the International Date Line corresponds to the direction of the Earth's rotation.

29. The method according to claim 27, wherein the date change pattern representing the International Date Line comprises a plurality of coordinates having a value on the first axis that corresponds to the International Date Line.

30. A non-transitory computer readable storage medium storing computer-executable instructions configured to direct a computing system to conduct the method of claim 17.

31. A computer system for displaying a schedule corresponding to an activity as a pattern of coordinates, the system configured to:
generate a coordinate system including a first axis and a second axis; and
generate a pattern of coordinates on the coordinate system generated by the coordinates generation module, the pattern of coordinates including at least one coordinate corresponding to the activity,
wherein the first axis corresponds to an absolute time line independent from a location of the activity, and the second axis corresponds to a local time at the location of the activity.

32. The computer system of claim 31 is further configured to:
when the activity includes a travel crossing the International Date Line, generate a date change pattern having a value corresponding to the International Date Line on the first axis.
